(19) United States
(12) Patent Application Publication
(10) Pub. No.: US 2004/0026466 A1
(43) Pub. Date: Feb. 12, 2004

(54) Pouring device for a liquid container

(76) Inventors: Joseph Lehner, Wels (AT); Izahir Salihi, Wels (AT)

Correspondence Address: Collard & Roe, 1077 Northern Boulevard, Roslyn, NY, 11576, US

(21) Appl. No.: 10/432,544

(22) PCT Filed: Nov. 27, 2001
(86) PCT No.: PCT/AT01/00373

(51) Int. Cl. B67D 3/00

(52) U.S. Cl. 222/547

(57) ABSTRACT

A pouring apparatus for a container for liquids with a pouring insert which consists of a holding device (3) for flow channels which are arranged in a ring-shape fashion around its central axis and project in the direction of said central axis into the container (2) for liquids, which holding device (3) can be inserted into the pouring opening (1) of the container (2). In order to provide advantageous constructional conditions it is proposed that the flow channels (6) are merely provided in an outer ring region and delimit a main channel (8).

### 1. FIELD OF THE INVENTION

The invention relates to a pouring apparatus for a container for liquids, comprising a pouring insert which consists of a holding device for flow channels which are arranged in a ring-shape fashion around its central axis and project in the direction of said central axis into the container for the liquids, which holding device can be inserted into the pouring opening of the container.

### 2. DESCRIPTION OF THE PRIOR ART

When pouring a liquid from a container through a pouring opening which otherwise is closed, an increasing pressure below atmospheric is produced in the container by the reduction of the volume of the liquid until an air breakthrough through the pouring opening leads to a pressure compensation with the consequence that a pressure below atmospheric builds up again in the container and the process is repeated. In order to avoid a thus caused irregular pouring stream which changes in a gush-like manner it is known (DE 196 52 216 A1) to insert in the pouring opening of the container a pouring insert in a plug-like fashion, which insert comprises a system of tubes through which the liquid flows from the container. The tubes of said tube system are arranged in concentric circles around the central axis of the pouring insert, with the tubes of the outer circle being of different length in an alternating manner. Since the shorter tubes form a constricted inlet opening, the respective uppermost of the short tubes will only fill partly with liquid in the case of a low tilting position of the container, so that at this location air is preferably sucked into the liquid container. If the tilting position is increased, air additionally reaches the container through the adjacent longer tubes as a result of the thus connected rise in the pressure below atmospheric in the container, leading to a pressure compensation adjusted to the respective tilting position of the container and subsequently to a pouring stream which is substantially independent of the tilting position of the container, which is namely due to the arrangement of the tubes in concentric circles irrespective of the rotary position of the pouring insert relative to the container. The disadvantageous aspect in this known pouring apparatus is however that the partial streams caused by the individual tubes need to be converged after emerging from the pouring insert into a common pouring stream, which may lead to disturbances depending on the viscosity of the liquid to be poured and the gusset regions obtained between the tubes. Moreover, the free flow cross section is limited to the sum total of the effective cross sections of the tubes, which respectively prolongs the emptying period of a container with such a pouring insert.

### SUMMARY OF THE INVENTION

The invention is thus based on the object of improving a pouring apparatus for a container for liquids of the kind mentioned above in such a way that an even pouring stream for different liquids can be ensured, namely by favorably utilizing the outlet cross section as predetermined by the pouring opening.

This object is achieved by the invention in such a way that the flow channels are provided merely in an outer ring region and delimit a main channel.

By providing a pouring insert with a main channel for the liquid to be poured, the disadvantages concerning the converging of the pouring stream which are linked to a system of tubes for the spout can be avoided in a simple fashion. Nevertheless, the advantages concerning the pressure compensation adjusted to the respective tilting position by the air which is taken in is ensured when the flow channels which are used both for guiding the liquid as well as the air are provided merely in an outer ring region. In cooperation with the main channel which is delimited by them, these flow channels allow an especially even, gush-free pouring stream in any tilting position of the container.

In order to achieve an advantageous pressure compensation through the flow channels projecting into the container, the flow channels can be provided with a flow cross section which tapers towards the end projecting into the liquid container. The flow channels expanded towards the pouring opening produce flow and pressure conditions which as a result of an even pressure compensation by the inflowing air ensure a disturbance-free formation of an even pouring stream.

Since merely the flow channels which are the uppermost in the tilting position of the container ensure pressure compensation by the air which is taken in, the flow channels merely need to be provided in a circumferential section of the pouring insert which is at the top during the tilting of the container in order to achieve the effect in accordance with the invention. Such a configuration of the flow channels which is limited to a circumferential section demands an alignment of the rotary position of the pouring insert with respect to the tilting position of the container during the pouring, which can be performed appropriately only in containers with a predetermined pouring direction, as is the case for example in canister-like containers for liquids, but is not the case in bottles or other rotation-symmetrical containers for liquids.

For a pouring apparatus which is independent of the shape of the container a construction can be recommended in which the holding device consists of an outside wall and an inner wall which is coaxial thereto and is preferably longer than the same and delimits the main channel. The flow channels are arranged in a manner so as to be distributed over the circumference between the inside and outside wall. The inside wall of the holding device which forms the main channel provides advantageous conditions for an alignment of the pouring stream due to its longer length. As a result of the distribution of the flow channels around the circumference of the holding device, the pouring apparatus becomes independent of the respective tilting direction of the container. The arrangement of the flow channels between the inside and outside wall of the holding device leads to advantageous preconditions for a sufficient strength of the pouring insert at comparatively low wall thicknesses. In order to support the converging of the pouring stream, the outside wall of the holding device can be extended via the inside wall to the outside.

When the flow channels are disposed between the inside and the outside wall of the holding device with a mutual distance in the circumferential direction, then this leads to additional flow paths between said flow channels which are limited in their length to the height of overlap of the outside and the inside wall, which additional flow paths can be used to produce the pressure compensation at a lower tilting position of the container through a respective suction of air. Said suction of air over shorter flow paths can also be secured in such a way that the flow channels are provided on the outer circumferential side with radial pass-through openings in the region of the sections projecting into the container, which pass-through openings can be used for sucking in air into the container in different distances of the output opening of said flow channels. Said radial pass-through openings on the outer circumferential side of the flow channels offer comparable effects concerning pressure compensation which is adjusted to different tilting positions of the container, so that under certain circumstances it is possible to omit shorter flow paths between the flow channels completely.

### BRIEF DESCRIPTION OF THE DRAWINGS

The subject matter of the invention is shown by way of examples in the drawings, wherein:

FIG. 1 shows a pouring apparatus in accordance with the invention for a container for liquids in a simplified side view;

FIG. 2 shows this pouring apparatus in a view in the direction of arrow II of FIG. 1;

FIG. 3 shows a sectional view along the line III-III of FIG. 2;

FIG. 4 shows a sectional view along the line IV-IV of FIG. 3, and

FIG. 5 shows a sectional view along the line V-V of FIG. 3.

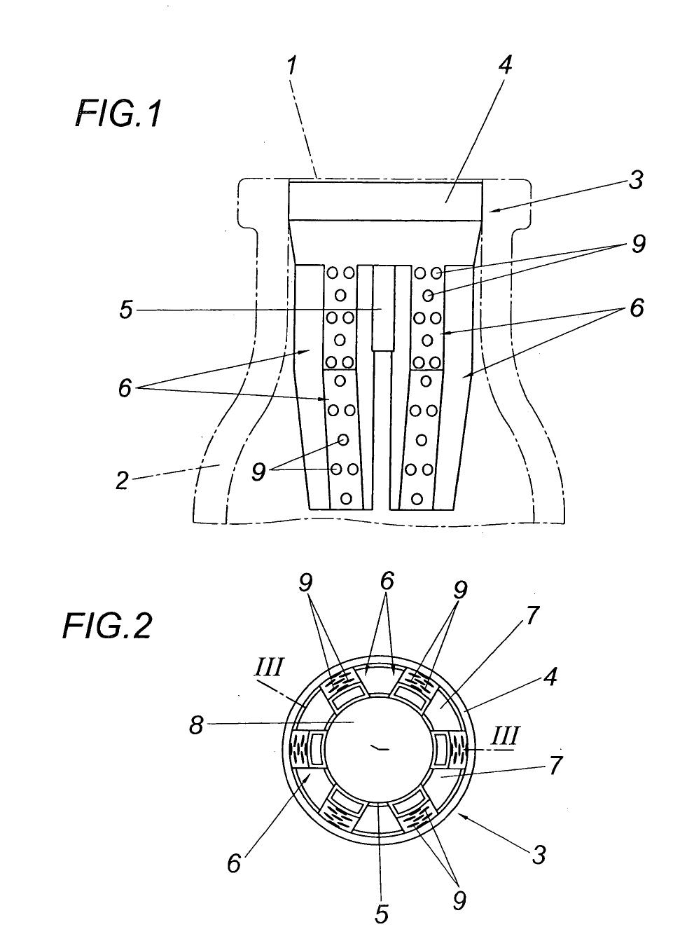

### DESCRIPTION OF THE PREFERRED EMBODIMENTS

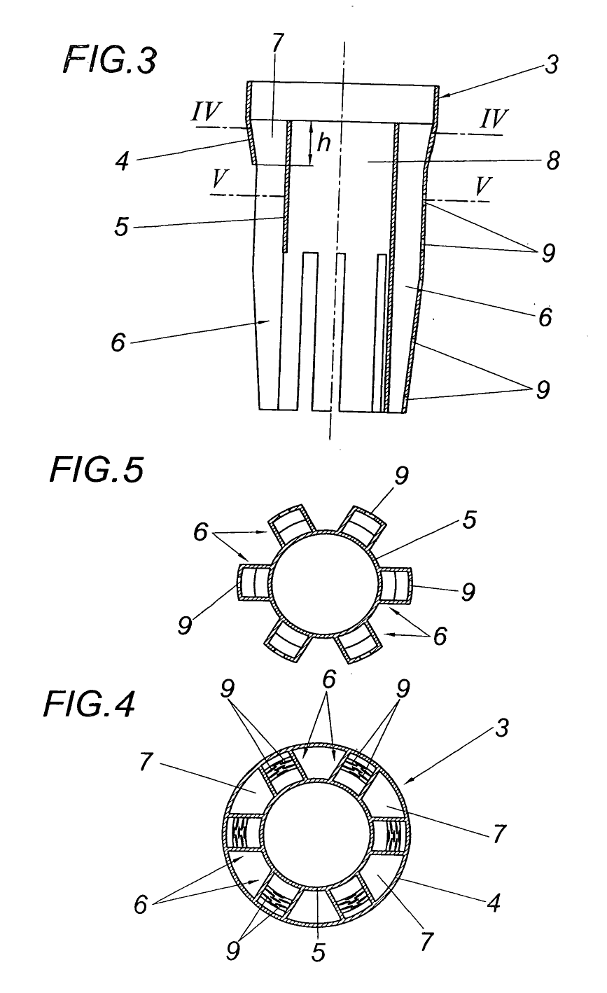

The illustrated pouring apparatus forms a pouring insert for a pouring opening 1 of a bottle-like container 2 for liquids as indicated in a dot-dash line. Said pouring insert consists of a holding device 3 which can be inserted into the pouring opening 1 and forms an outside wall 4 and an inside wall 5 extending at a radial distance therefrom. Flow channels 6 which are distributed over the circumference are provided between the outside wall 4 and the inside wall 5, which flow channels project into the interior of the container and are provided with a flow cross section which tapers towards the projecting end, as is shown especially in the longitudinal sectional view of a flow channel 6 in FIG. 3. Since the flow channels 6 are arranged in the circumferential direction at a distance from each other, additional flow paths 7 are obtained between the flow channels 6, which flow paths have an effective length which corresponds to the height of overlap h of the outside wall 4 and the inside wall 5 of the holding device 3. The inside wall 5 which is extended relative to the outside wall 4 towards the interior of the container encloses a main channel 8 for the outlet of the liquid.

When pouring a liquid from the container 2 which needs to be placed in the tilted position for this purpose, the air to be sucked into the container 2 for the purpose of pressure compensation is sucked in at first through the short flow paths 7 in the circumferential region of the holding device 3 which is the uppermost as is given by the tilting position before the flow channels 6 begin to suck in air in said upper circumferential region in the case of an increase in the tilting inclination. This allows producing a continuous pressure compensation in the container 2 which allows taking into account the respective tilting position of the container 2 with the consequence that an even, gush-free pouring stream is obtained which is converged into a uniform stream with the liquid streams through the flow channels 6 and flow paths 7 without leading to any irregularities by the secondary streams obtained parallel to the main channel 8. The converging of the pouring stream is supported by the outside wall 4 which is outwardly extended beyond the inside wall 5.

In order to ensure a substantially continuous adjustment of the pressure compensation to different tilting positions, the flow channels 6 can be provided on the outer circumference with radial pass-through openings 9 which depending on the given pressure conditions will assume the air guidance. In the case of a respective arrangement of the pass-through openings 9, it is also possible to omit the flow paths 7 between the flow channels 6.

It is understood that the invention is obviously not limited to the illustrated embodiment. Accordingly, the number of flow channels 6 can be chosen differently depending on the diameter of the pouring opening 1. The flow channels 6 also need not be distributed over the entire circumference of the holding device 3 when it is ensured that the flow channels 6 come to lie in an upper circumferential region of the holding device 3 during a tilting movement of the container 2 for pouring out the liquid in a predetermined direction.

1. A pouring apparatus for a container for liquids, comprising a pouring insert which consists of a holding device for flow channels which are arranged in a ring-shape fashion around its central axis and project in the direction of said central axis into the container for liquids, which holding device can be inserted into the pouring opening of the container, characterized in that the flow channels (6) are merely provided in an outer ring region and delimit a main channel (8).

2. A pouring apparatus as claimed in claim 1, characterized in that the flow channels (6) comprise a flow cross section tapering towards the end projecting into the container (2).

3. A pouring apparatus as claimed in claim 1 or 2, characterized in that the holding device (3) consists of an outside wall (4) and an inner wall (5) which is coaxial thereto and is preferably longer than the same and delimits the main channel (8) and that the flow channels (6) are arranged in a manner so as to be distributed over the circumference between the inside and outside wall (5, 4).

4. A pouring apparatus as claimed in claim 3, characterized in that the outside wall (4) is extended to the outside beyond the inside wall (5).

5. A pouring apparatus as claimed in one of the claims 1 to 4, characterized in that the flow channels (6) are arranged so as to be spaced from each other in the circumferential direction.

6. A pouring apparatus as claimed in one of the claims 1 to 5, characterized in that the flow channels (6) are provided on the outer circumferential side with radial pass-through openings (9) in the region of the sections projecting into the container (2).
